(19) United States
(12) Patent Application Publication
(10) Pub. No.: US 2007/0150315 A1
(43) Pub. Date: Jun. 28, 2007

(54) Policy driven access to electronic healthcare records

(75) Inventors: Craig A. Bennett, Woodstock, GA (US); Effron F.D. Esseiva, Anmore (CA); Tomer Kol, Yoqneam-Illit (IL); Richard J. Stevens, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/316,262

(22) Filed: Dec. 22, 2005

(51) Int. Cl. G06F 19/00; G06F 17/30; H04L 9/00

(52) U.S. Cl. 705/3; 707/9; 726/1

(57) ABSTRACT

A method and article of manufacture for managing access to electronic healthcare records is disclosed. Embodiments of the invention generally allow individuals to define an access policy regarding electronic healthcare records and health care providers who may have shared access to a data repository storing the records. Typically, the access policy specifies whether access to groups of records that are related to the diagnosis of a particular condition or that are related to a particular episode of care may be shared among multiple providers, including providers not responsible for creating a particular record.

### BACKGROUND OF THE INVENTION

1. Field of the Invention

The present invention generally relates to managing shared access to records stored in a computer database. More specifically, the present invention relates to a framework for enforcing access restrictions to electronic healthcare records based on individual choices embodied in a records access policy.

2. Description of the Related Art

When an individual visits a physician, hospital, or clinic, numerous records related to the visit may be created. Records such as lab results, x-rays and other images, prescriptions, and notes regarding treatment decisions, provide a few common examples of records that may be created as a result of a treatment encounter between a patient and a physician. Such records also often reflect the diagnosis of some disease or condition along with a prescribed course of treatment. Historically, the medical records related to a particular individual or treatment encounter have been maintained by the provider responsible for creating a particular record. For example, an individual's primary care physician typically maintains any records related to treatment encounters involving the primary care physician. Thus, when an individual visits the primary care physician for an annual physical exam, the records related to the exam are created and stored at the office of the primary care physician. Similarly, if an individual receives emergency care at an emergency room, the attendant hospital has historically maintained records of the care provided at the emergency room.

The sharing of electronic healthcare records, when it occurs at all, requires a requesting provider to contact the provider with the records. Once requested, the records must then be copied and transmitted to the requesting provider. Typically, the individual to whom the records are related must authorize the provider holding the records to disclose them to the requesting provider. More often, however, one provider may make treatment decisions without the benefit of information reflected in medical records that are in the possession of others.

Like records maintained for virtually every other profession, medical records have begun to migrate from paper to electronic forms, and computer databases are frequently used to store electronic medical records. Computer databases are well known systems used to store, maintain, and retrieve data. Generally, a database is a collection of data that is organized in a manner to allow its contents to be easily accessed, managed, and updated. The most prevalent type of database used today is the relational database, which organizes data using tables, and relationships between tables. For example, the DB2® family of RDBMS products (relational database management system) available from International Business Machines (IBM) provides a sophisticated commercial implementation of a relational database.

Using practice management software, many physicians, clinics, and hospitals have transitioned to a “paperless office” where medical records are created, managed, and stored in an electronic form. Such systems may integrate records from a variety of sources, e.g., referrals to other physicians such as a specialist, the ordering and results of various lab tests or procedures as well as the treatment observations and recommendations of the primary care physician. Typically, however, like their historical paper counterparts, electronic medical records are stored by the provider creating the records. Thus, while the primary care physician may use sophisticated practice management software tools to manage electronic medical records, the records are typically still localized to the office of the primary care physician. While these systems work as intended, a great deal of focus has been directed toward the prospect of creating regional, national, and even global networks of shared access to electronic medical records, and many initiatives and pilots programs are either underway or being considered to provide broader access to medical records.

The goal is to allow health care providers to have access to a comprehensive collection of electronic medical records related to a given patient. To this end, some general models have emerged. First, a centralized approach may be used to store electronic records accessed by multiple providers. Such an approach may centralize records over a local, regional, or national basis, and any provider with access to a centralized repository may access an individual's medical records, regardless of the provider that created the records. An alternative approach is to leave medical records widely distributed, and build a federated database model to allow one provider to access the records of another. Finally, hybrids of the first two approaches are also being considered and implemented. Whatever approach ultimately emerges from these proposals and pilot programs, eventually a requesting entity, be it a physician, nurse, clinician, etc., may be able to gain access to a comprehensive set of medical records regarding particular individual, regardless of the provider who created the record.

Access to this information is likely to be extremely beneficial, as neither individual patients nor healthcare professionals can always predict what information available from an individual's history may be useful in providing the best quality of care. At the same time however, individuals will strongly desire to have some control over what providers may access certain records, especially in an environment where different providers have shared access to an individual's medical records. To name an obvious example, an individual may not wish allow a provider treating an individual for food poisoning to access the electronic records regarding psychiatric treatment created by another provider. As a more subtle example, a person may wish to limit access to a certain records provided to a physician performing an exam on behalf of an employer or insurer. Thus, under some circumstances an individual may legitimately wish to conceal treatment history related to a particular episode or diagnosis from some providers.

Furthermore, without some level of individual consent and active participation many individuals may decline to allow their electronic medical records to be shared as part of a shared access infrastructure. Accordingly, as shared access to electronic medical records becomes feasible, there remains a need for a mechanism to both capture and enforce an individual's choices regarding shared access to electronic medical records.

### SUMMARY OF THE INVENTION

Embodiments of the present invention generally provide a privacy layer between a collection of electronic records and a group of health care providers who may have access to the records.

One embodiment of the invention provides a computer implemented method for processing requests for electronic records pertaining to individuals. The method generally includes, receiving a request, wherein the request identifies at least an individual that is the subject of the request and a requesting party, and determining a set of electronic records responsive to the request, wherein each electronic record is related to an encounter between a healthcare provider and the individual. From the set of electronic records responsive to the request, the method generally further includes (i) identifying an electronic record indicative of a particular health-related condition, and (ii) determining each record in the set of electronic records associated with the particular health-related condition. The method still generally further includes accessing an access policy associated with the individual to determine whether the access policy specifies that electronic records associated with the particular health-related condition may be disclosed to the requesting party, and returning the electronic records associated with the particular health-related condition only if the access policy specifies that records associated with the particular health-related condition may be disclosed. Another embodiment of the invention includes a computer-readable medium containing a program, which when executed on a processor, performs operations processing a request for electronic records regarding an individual. The operations generally include, receiving a request, wherein the request identifies at least an individual that is the subject of the request and a requesting party, and determining a set of electronic records responsive to the request, wherein each electronic record is related to an encounter between a healthcare provider and the individual. From the set of electronic records responsive to the request, the operations generally further include (i) identifying an electronic record indicative of a particular health-related condition, and (ii) determining each record in the set of electronic records associated with the particular health-related condition. The operations still generally further include accessing an access policy associated with the individual to determine whether the access policy specifies that electronic records associated with the particular health-related condition may be disclosed to the requesting party, and returning the electronic records associated with the particular health-related condition only if the access policy specifies that records associated with the particular health-related condition may be disclosed.

Still another embodiment of the invention provides a computer-implemented method for managing access to electronic records stored in a shared access data repository. The method generally includes identifying a set of electronic records related to an individual, wherein the records in the shared access data repository are accessible by a plurality of health care providers and identifying at least one of the electronic records indicative of a health-related condition of the individual. This method generally further includes determining each record, from the set of records, that is associated with the health-related condition, and selecting an access policy for the set of records associated with the identified health-related condition.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the exemplary embodiments illustrated in the appended drawings.

Note, however, that the appended drawings illustrate only typical embodiments of this invention and are therefore not to be considered limiting of its scope, for the invention may admit to other equally effective embodiments.

FIG. 1 is a block diagram illustrating the interactions between an individual and a number of health care providers that may have shared access to electronic records, according to one embodiment of the invention.

FIG. 2 is a block diagram illustrating the relationships between a data access manager and other software components, according to one embodiment of the invention.

FIG. 3 further illustrates a data access manager configured to restrict access to a shared collection of electronic records, according to one embodiment of the invention.

FIG. 4 is a flow chart illustrating a method for responding to a request to retrieve a set of electronic records, taking into account data access policies in place for an individual identified in the request, according to one embodiment of the invention.

FIG. 5 is a flow chart illustrating a method for categorizing a collection of electronic records into episodes of care, according to one embodiment of the invention

FIG. 6 illustrates an exemplary user interface configuration that allows a user to specify aspects of an access policy, according to one embodiment of the invention.

### DETAILED DESCRIPTION OF THE PREFERRED EMBODIMENTS

Embodiments of the present invention generally allow individuals to create an access policy regarding (i) a collection of electronic records and (ii) health care providers who may have shared access to the records. In one embodiment, an individual may specify an access policy for records related to an individual encounter or for specific electronic records that are available in a shared access repository. More generally however, rather than setting an access policy for individual electronic records, embodiments of the invention allow a user to specify an access policy for collections of records that are related to the diagnosis of a particular condition or that are related to a particular episode of care.

As used herein, an “episode of care” refers to a set of electronic records logically related to the diagnosis or treatment of a condition. Thus, an episode of care may encompass a broad set of encounters with a healthcare provider (e.g., any encounter with the healthcare system such as a physician visit, blood test, prescription order, prescription fulfillment, hospital admittance, hospital release, medical imaging, or lab results, etc.), based on the date of encounter, diagnosis, and outcome, as reflected by any electronic records generated during groups of related encounters.

In one embodiment, a data access manager may parse a set of electronic records to identify episodes of care regarding an individual patient. For example, the healthcare industry relies heavily on standardized codes for categorizing healthcare encounters. These diagnosis and treatment protocol codes may be used to sort electronic records from different encounters into different episodes of case. By categorizing encounters (and corresponding electronic records) into various episodes of care, creating an access policy may become more straightforward to individuals, as the episodes of care reflect the overall condition or diagnosis to which the individual records are related. An individual may then specify an access policy for all of the records related to an episode of care. Accordingly, individuals may make more informed choices when defining an access policy regarding a collection of shared records.

An access policy regarding shared access to electronic records may also specify additional restrictions such as when records will be shared and with whom. This may allow an individual to grant temporary access to all or some shared records. For example, an individual may grant complete access to a cardiac specialist for a limited time. Alternatively, an individual may choose to grant the cardiac specialist with access to only physical exam information and related lab results, so that the cardiac specialist can examine trend data. At the same time, the individual may chose an access policy that prevents the cardiac specialist from accessing records related to other episodes of care.

Further refinements to an access policy may include override conditions or allowing an individual to specify that non-identifying or “anonymized” information may be accessed and disclosed for research purposes. Other policy restrictions or access policy conditions may occur to one of ordinary skill in the art and are, therefore, contemplated within the scope of the present invention.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

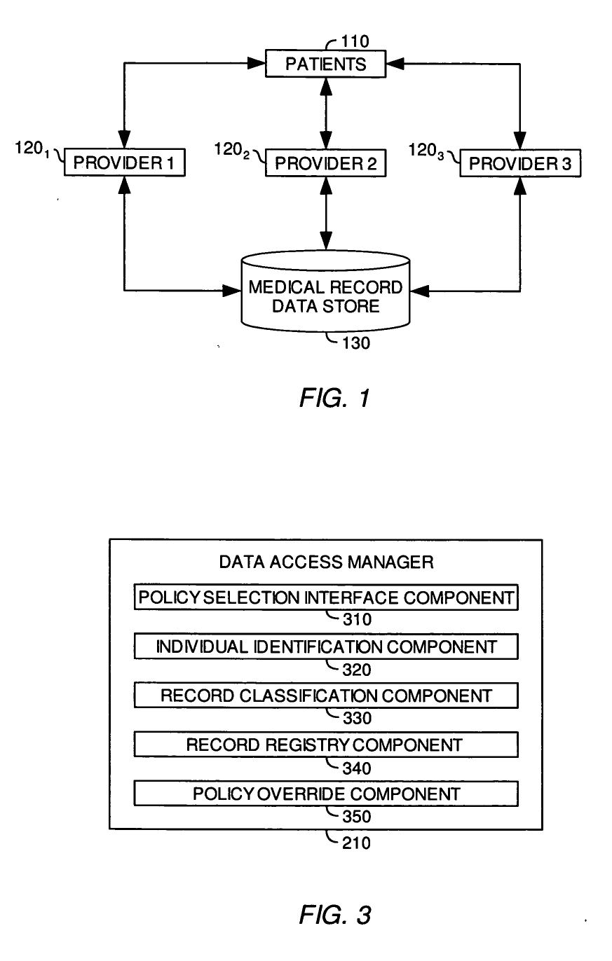

Further, embodiments of the invention may be implemented using computer software applications executing on existing computer systems, e.g., desktop computers, server computers, laptop computers, tablet computers, and the like. The software applications described herein, however, are not limited to any currently existing computing environment or programming language, and may be adapted to take advantage of new computing systems as they become available. Additionally, the components illustrated in FIG. 1 may be executing on individual computer systems or distributed systems communicating over computer networks including local area networks or large, wide area networks, such as the Internet

One embodiment of the invention is implemented as a program product for use with a computer. The program(s) of the program product defines functions of the embodiments (including the methods described herein) and can be contained on a variety of computer-readable media. Illustrative computer-readable media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information to/from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

FIG. 1 is a block diagram illustrating the interaction between an individual and a number of health care providers that may have shared access to electronic records, according to one embodiment of the invention. As shown, an individual 110 may interact with providers 120₁, 120₂, and 120₃ (three shown only by way of example) to receive some form of medical treatment or care for which electronic records may be created and stored in record data store 130.

Accordingly, each of the providers 120₁, 120₂, and 120₃ represent any individual, entity, or organization that provides health care related goods or services to, or on behalf of, the individual 1 10. Representative examples of a health care provider 120 include traditional treatment providers, such as the private practice offices of a physician, a clinic, a hospital, and a university medical school or research facility. However, providers 120 may also represent other health-care related entities such as a pharmacy or a physical therapy center. More generally, the providers 120 represent any entity with access to the shared collection of electronic records available from data store 130 regarding patient 110.

In one embodiment, a provider 120 may create and store electronic records in a record data store 130. For example, during a treatment encounter, a variety of electronic records may be created. “Electronic healthcare records” or “electronic records” may include data created or related to doctor visits, lab tests, hospital stays, clinical trials, diagnoses (including self-diagnoses), prognoses, records, etc. Typically, hospitals, clinics, and private practice groups may use practice management software to create, store, manage, and access to electronic records regarding an individual 110. More generally, the information in data store 130 includes any information related to the individual 110 that may be represented in a digital form. In one embodiment, such electronic records may be stored in record data store 130. Each of the providers 120 is shown with access to data store 130, and each provider 120 may access electronic records created by one of the other providers.

For simplicity, data store 130 is shown as a single data repository, accessed by each of the providers 120. It being understood, however, that many physical infrastructures may be used to provide each of the providers 120 with shared access to a set of electronic records in data store 130. As described above, for example, infrastructure models that include centralized approaches, decentralized approaches, and hybrids of both may be used to provide shared access to electronic records. Accordingly, embodiments of the invention may include record data store 130 using an underlying physical infrastructure configured in many different ways, and are broadly contemplated within the scope of the present invention.

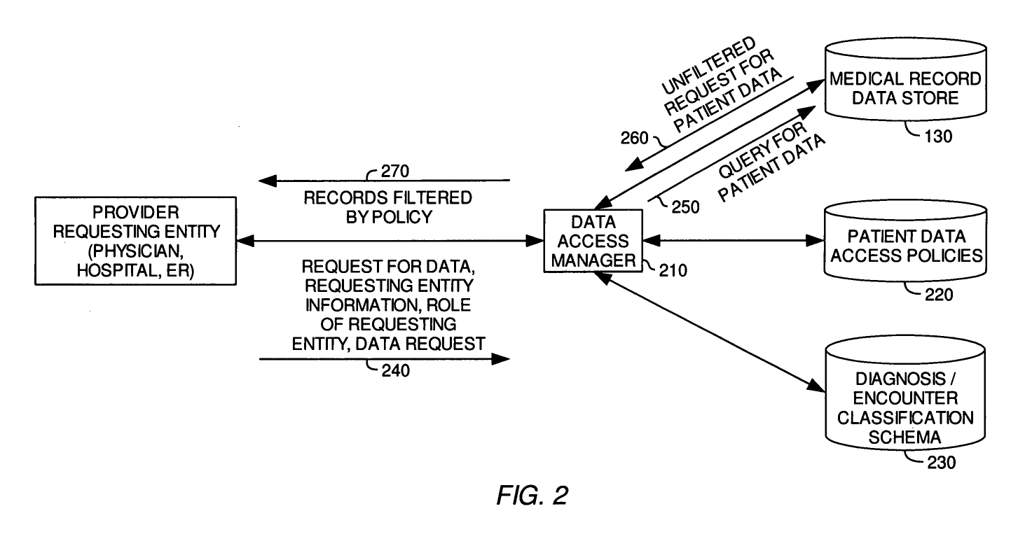

FIG. 2 is a block diagram illustrating the relationships between a data access manager 210 and other software components, according to one embodiment of the invention. As shown, provider 120 submits a request for access to electronic records from record data store 130. For example, a physician may submit a request in any number of care settings, e.g., private practice, emergency room, research activity, etc. The records returned in response to such a request may be filtered according to data access policies 220. In one embodiment, data access manager 210 is a software component configured to process such requests, and to enforce patient data access policies 220. Accordingly, the data access manager 210 may be configured to access to patient records in shared record data store 130, patient data access policies 20 and diagnosis/encounter classification data 230.

In one embodiment, the classification data 230 may rely on standardized codings used by the healthcare industry. For example, the widely used International Statistical Classification of Diseases and Related Health Problems-9 (ICD-9) standards may be used to identify a record indicative of some medical condition experienced by a given individual. Using such codings, a group of electronic records all related to the diagnosis or treatment of a particular health-related (e.g., medical) condition may be identified. For example, the classification data 230 may include a set of inferential rules based on a particular ICD-9 diagnosis code. Based on the rules, the data access manager 210 may be configured to associate records created during various encounters with an episode of care. For example, a rule may specify that electronic records regarding diagnostic tests ordered to determine the particular medical condition may be included in an episode of care. Similarly, records created after the diagnosis of a medical condition may be included in an episode of care. For example, a record of a prescription for medication known to be appropriate for treating the medical condition identified by the diagnosis code may be included in the episode of care.

By using the diagnosis and treatment protocol codings to identify groups of logically related records, individuals may better understand and choose to share (or restrict) access to electronic records related to a particular medical condition. The access policies 220 may provide various degrees of granularity for an episode of care, and may be used to restrict access to the group of records associated with a particular episode of care or medical condition. For example, access policies 220 may restrict access to specific electronic records (or types of records) associated with a particular episode of care. More generally, however, by allowing an individual to define an access policy 220 relative to an episode of care, the individual does not have to understand how each encounter, or how the substance of a particular electronic record, relates to the others.

Generally, the provider 120 submits a request 240 to data access manager 210. The request 240 may include the identity of the individual that is the subject of the request along with the identity of the entity submitting the request. For example, individuals may be identified using a patient ID scheme that assigns a unique ID number to each individual with records in data store 130, and a physician may be identified using techniques such as usernames and passwords. Alternatively, more sophisticated cryptographic protocols may be used to provide identification and authentication services. In addition, the request may include an indication of records by type or classification being sought in response to the request. For example, a physician may wish to retrieve patient records related to specific encounters, related to a particular type of record (e.g., all blood tests), or records related to different episodes of care (e.g., all records related to treatment for a specified diagnosis or condition).

After receiving a request, the data access manager may be configured to verify the identity and authenticity of a requesting entity. Once a request is verified, the data access manager 210 may submit query 250 to medical record data store 130. In response, the unfiltered set of data records 260 may be returned to the data access manager 210. In one embodiment, the data access manager may classify each record into one or more episodes of care according to diagnoses/encounter classification schema 230. Once the records have been classified, the patient access policy for the individual specified in the request may be used to filter the unfiltered set of medical records. The filtered set of records 270 is then returned to the requesting entity.

FIG. 3 further illustrates a data access manager 210, according to one embodiment of the invention. As shown, data access manager 210 includes a policy selection interface component 310, an individual identification component 320, a record classification component 330, a record registry component, 340 and a policy override component 350. Although each of the components 310-350 are shown internal to the data access manager, some, or all of these components may be provided as services to the data access manager (e.g., in a distributed environment with a number of interacting client/server processes).

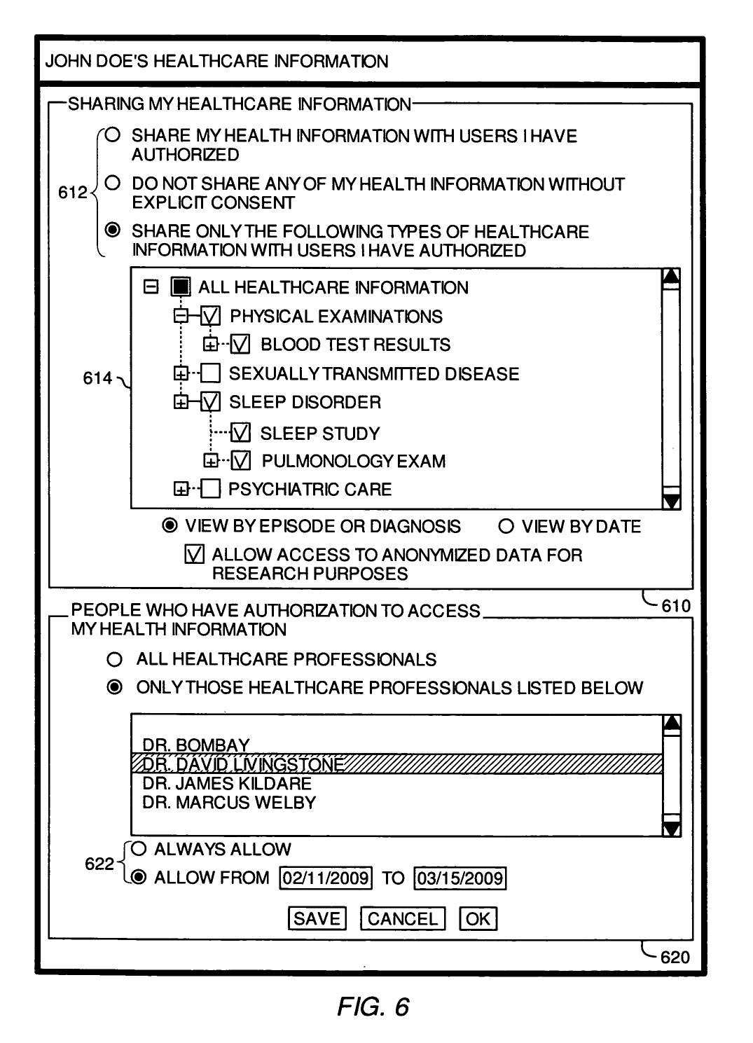

In one embodiment, the policy selection interface component 310 allows an individual 110 with electronic records stored in the shared access data store 130 to specify an access policy for such records. For example, the policy selection interface component 310 may provide individuals with a web-based interface to specify access choices. FIG. 6 illustrates an exemplary user interface configuration that allows a user to specify aspects of an access policy 220, according to one embodiment of the invention.

The data access manager 210 may use the individual identification component 320 to identify an individual that is the subject of a data request 240. Such a component may be used to resolve patient ID values used by various providers into an ID value used by the data access manager 110. This would allow each provider to continue to use existing patient ID values when participating in a shared access infrastructure.

The record classification component 330 may be configured to classify and categorize records related to individual treatment encounters into one or more episodes of care. As described above, for example, the diagnoses/encounter classification schema 230 may rely on existing coding standards such as the International Statistical Classification of Diseases and Related Health Problems-9 codes (ICD-9) to categorize electronic records into episodes of care.

The record registry component 340 may provide an index of records in shared access data store 130. In one embodiment, the registry provides a list that includes the individual to whom a record is related, an indication of the source of the record, and an indication of the location of the record. For example, in a federated environment where data store 130 may be spread across multiple data nodes, the record registry component 340 may indicate which node stores a particular electronic record.

The policy overrides component 350 may be configured to override the access policy 220 for certain records in some cases. For example, unrestricted access may be granted to electronic records in data store 130 for a patient brought unconscious to an emergency room. Another reason may be legislative requirements or regulatory compliance. For example, a body like the CDC may have access rights to certain types of records (e.g., for a diagnosis of certain communicable diseases).

To protect the individual 110 however, any override of a defined access policy may be performed in a controlled and traceable way, and the entity requesting the override must be traceable and accountable. Accordingly, policy overrides component 350 may be configured to determine when policy overrides should occur, and also to log the circumstances of such occurrences for later review.

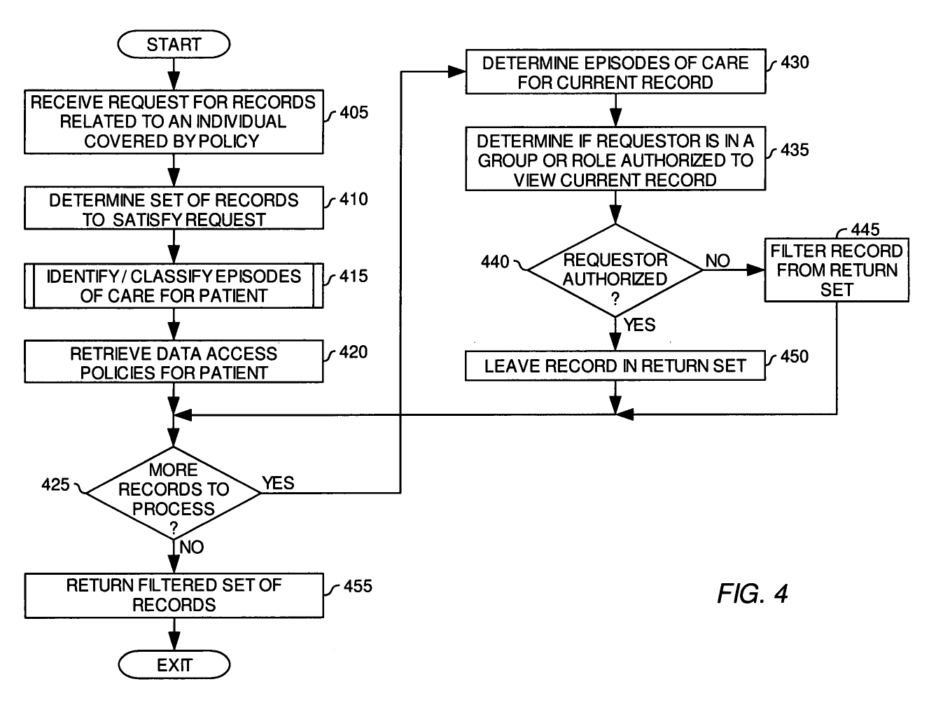

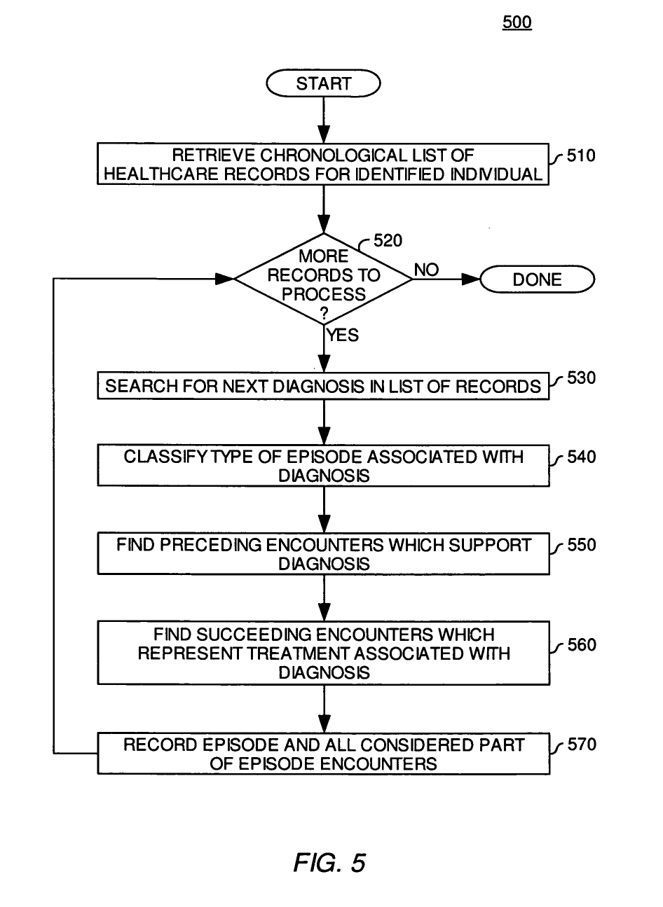

FIG. 4 is a flow chart illustrating a method for responding to a request to retrieve a set of electronic records, taking into account a data access policy for an individual identified in the request, according to one embodiment of the invention. The method 400 may be performed by the data access manager 210 in response to a request for electronic records in a shared access data store 130 submitted by a provider 120. The method 400 begins at step 405 where a request 240 is received by data access manager 210. As described above, the request 240 may include the identity of the individual that is the subject of the request along with the identity of the physician submitting the request. At step 410, a set of electronic records responsive to the request is retrieved from the shared access data store 130. At step 415, the records retrieved at step 410 are categorized or classified into one or ore more episodes of care. The actions of the data access manager 210 regarding this step are further described below in reference to FIG. 5.

At step 420, the data access manager may retrieve the access policy defined for the relevant individual 110. At step 425, a loop beings that includes step 430-450. For each pass through this loop, the data access manager may be configured to determine whether the particular requesting entity is authorized to access a particular electronic record, based on the access policy of the relevant individual.

Accordingly, at step 430, the data access manager 210 determines any episodes of care associated with the electronic record under consideration. At step 435, the data access manager 210 determines whether the electronic record under consideration may be disclosed according to the access policy defined for the relevant individual. Based on this determination, at step 440, the record may be filtered from a set of data records responsive to the request (step 445). Otherwise, if the access policy authorizes access the requesting provider to access the record under consideration, then the record is left in the result set (step 450). After processing the records retrieved from the shared access data store 130, the records that the requesting entity is authorized to access, if any, are returned at step 455.

FIG. 5 is a flow chart illustrating a method 500 for categorizing a collection of electronic records into episodes of care, according to one embodiment of the invention. The method 500 further illustrates actions that may be performed by the data access manager as part of step 415 of the method 400 shown in FIG. 4. The method 500 begins at step 510 where the data access manager 210 retrieves a chronological list of health care records regarding the patient that are available from shared access data store 130. At step 520, a loop beings that includes step 430-450. For each pass through this loop, the data access manager 210 may identify an episode of care, and determine a set of electronic records to associate with the episode of care. Accordingly, at step 530, the next diagnosis of a condition is determined. For example, the data access manager 210 may traverse through the chronological list of records until a diagnosis is identified (e.g., by identifying an ICD-9 code). In one embodiment, the data access manager 210 searches only for diagnosis codes that have an associated access policy condition or restriction associated with a given high-level condition. Thus, if an access policy for a particular individual is silent regarding a diagnosis of benign conditions such as “flu” or “common cold,” these codes are not used to create an episode of care. Conversely, for a medical condition that is associated with an episode of care identified in an access policy, records related to that episode of care are identified and marked as such.

Thus, once a relevant episode of care is identified, the method 500 proceeds to step 540 where the data access manager 210 associates the medical condition with an episode of care. For example, as described above, an episode of care may be related to high level descriptions of medical diagnoses or conditions such as “mental health records” or “sexually transmitted diseases.” For such broad identifiers, many different diagnosis codes may be related to the episode of care.

At step 560 the data access manager 210 may parse through previous encounters in the chronological list to identify electronic records associated with the diagnosis or condition identified at step 530. Similarly, at step 560, the data access manager 210 may parse through subsequent encounters to identify electronic records associated with the diagnosis or condition identified at step 530. At step 560, after parsing through the electronic records, the association based on individual records with the current diagnosis/episode of care is recorded.

FIG. 6 illustrates an exemplary user interface configuration that allows an individual 110 to specify aspects of an access policy 220, according to one embodiment of the invention. Generally, dialog box 600 allows an individual 110 to set an access policy for a set of records stored in shared data store 130. For example, pane 610 allows the individual to specify an access policy based for electronic records, based on the episodes of care to which a given record may be related. Radio buttons 612 provide various choices that an individual 110 may select regarding how electronic records may be shared with providers 120. As shown, the individual has selected to share different records related to some, but not all categories of episodes of care listed in pane 614. Specifically, pane 614 displays a hierarchy of episodes of care, with checkboxes used to indicate whether a provider 120 with access to the shared access store 130 may access electronic records regarding the identified episode of care. As shown, the individual 110 has selected to share electronic records related to “physical examinations” and “sleep disorders” with the physicians identified in pane 620. At the same time, electronic records related to sexually transmitted diseases and psychiatric care is left unchecked, indicating that electronic records related these episodes of care should not be shared with a provider who did not create the records.

Pane 620 allows the individual 110 to specify access policy restrictions based on the identity of a provider 120 that may have access to records in the shared data store 130. Note however, the dialog box 600 illustrated in FIG. 6 is merely exemplary, and many other graphical and non-graphical interfaces may be used to allow an individual to specify an access policy regarding the shared access to electronic records.

As described, embodiments of the invention allow electronic healthcare records created during treatment encounters to be associated, with various episodes of care. Individuals may then specify an access policy regarding an episode of care. Instead of deciding whether to share access to each specific electronic record, individuals may specify an access policy based on the high level episodes of care. Thus, the individual's choice of whether to share information is significantly easier. Moreover, such a choice may be more informed. That is, by categorizing the individual records stored in data store 130, an individual may more intelligently decide what electronic records to share with the healthcare community. This may help minimize the possibility that an individual shares encounter information that may not seem related to an episode of care, but would indicate to a healthcare professional the nature of the episode that the patient wishes to make private—i.e. a blood test that is related to the diagnosis or treatment of a certain high-level condition that an individual wishes to keep private. Conversely, this may help minimize the possibility that an individual marks as private benign information that would be useful to a physician. For example, knowing that blood tests may be related to the diagnosis or treatment of certain high-level conditions, an individual may restrict access to all blood tests, including ones the patient would not object having disclosed to multiple physicians. This may result in physicians having to needlessly re-run those tests or to not have access to desirable information.

Additionally, by allowing users to specify that benign or non-identifying information may be shared with the research community, a collection of electronic healthcare records from many providers may become a valuable source of research information.

While the foregoing is directed to embodiments of the present invention, other and further embodiments of the invention may be devised without departing from the basic scope thereof, and the scope thereof is determined by the claims that follow.

What is claimed is:

1. A computer implemented method for processing requests for electronic records pertaining to individuals, comprising:
receiving a request, wherein the request identifies at least an individual that is the subject of the request and a requesting party;
determining a set of electronic records responsive to the request, wherein each electronic record is related to an encounter between a healthcare provider and the individual;
from the set of electronic records responsive to the request:
(i) identifying an electronic record indicative of a particular health-related condition; and
(ii) determining each record in the set of electronic records associated with the particular health-related condition;
accessing an access policy associated with the individual to determine whether the access policy specifies that electronic records associated with the particular health-related condition may be disclosed to the requesting party; and
returning the electronic records associated with the particular health-related condition only if the access policy specifies that records associated with the particular health-related condition may be disclosed.

2. The method of claim 1, wherein the access policy specifies one or more health-related conditions for which the individual has selected to prohibit shared access.

3. The method of claim 1, wherein the access policy specifies one or more health-related conditions for which the individual has selected to allow shared access.

4. The method of claim 3, wherein the access policy further specifies that access to the electronic records regarding the individual is allowed for a particular health care provider or for a particular period of time.

5. The method of claim 1, wherein the access policy specifies that access to the electronic records regarding the individual may be shared anonymously for research purposes.

6. The method of claim 1, wherein the individual specifies the access policy defined for the set of electronic records.

7. The method of claim 1, wherein the electronic records are stored in a shared access data repository, and wherein multiple, independent health care providers submit requests for access to electronic records.

8. The method of claim 1, wherein identifying the electronic record indicative of the particular health-related condition comprises identifying at least one electronic record that includes a standardized diagnosis code associated with the particular health-related condition.

9. The method of claim 1, wherein identifying an electronic record indicative of the particular health-related condition comprises, identifying an electronic record reflecting information selected from at least one of diagnostic information and test information related to diagnosing the health-related condition.

10. A computer-readable medium containing a program, which when executed on a processor, performs operations processing a request for electronic records regarding an individual, comprising:
receiving a request, wherein the request identifies at least an individual that is the subject of the request and a requesting party;
determining a set of electronic records responsive to the request, wherein each electronic record is related to an encounter between a healthcare provider and the individual;
from the set of electronic records responsive to the request:
(i) identifying an electronic record indicative of a particular health-related condition; and
(ii) determining each record in the set of electronic records associated with the particular health-related condition;
accessing an access policy associated with the individual to determine whether the access policy specifies that electronic records associated with the particular health-related condition may be disclosed to the requesting party; and
returning the electronic records associated with the particular health-related condition only if the access policy specifies that records associated with the particular health-related condition may be disclosed.

11. The computer-readable medium of claim 10, wherein the access policy specifies one or more health-related conditions for which the individual has selected to prohibit shared access.

12. The computer-readable medium of claim 10, wherein the access policy specifies one or more health-related conditions for which the individual has selected to allow shared access.

13. The computer-readable medium of claim 12, wherein the access policy further specifies that access to the electronic records regarding the individual is allowed for a particular health care provider or for a particular period of time.

14. The computer-readable medium of claim 10, wherein the access policy specifies that access to the electronic records regarding the individual may be shared anonymously for research purposes.

15. The computer-readable medium of claim 10, wherein the individual specifies the access policy defined for the set of electronic records.

16. The computer-readable medium of claim 10, wherein the electronic records are stored in a shared access data repository, and wherein multiple, independent health care providers submit requests for access to electronic records.

17. The computer-readable medium of claim 10, wherein identifying the electronic record indicative of the particular health-related condition comprises identifying at least one electronic record that includes a standardized diagnosis code associated with the particular health-related condition.

18. The computer-readable medium of claim 10,-wherein identifying an electronic record indicative of the particular health-related condition comprises, identifying an electronic record reflecting information selected from at least one of diagnostic information and test information related to diagnosing the health-related condition.

19. A computer-implemented method for managing access to electronic records stored in a shared access data repository:
identifying a set of electronic records related to an individual, wherein the records in the shared access data repository are accessible by a plurality of health care providers;
identifying at least one of the electronic records indicative of a health-related condition of the individual;
determining each record, from the set of records, that is associated with the health-related condition;
selecting an access policy for the set of records associated with the identified health-related condition.

20. The method of claim 15, wherein the individual specifies the access policy for the health-related condition.

21. The method of claim 15, wherein determining the access policy comprises, selecting to prohibit shared access to the set of records.

22. The method of claim 15, wherein determining the access policy comprises, selecting to allow shared access to the set of records.

23. The method of claim 15, wherein the access policy further specifies that access to the electronic records regarding an individual may be shared anonymously for research purposes.

24. The method of claim 15, wherein the electronic records are stored in the shared access data repository, and wherein multiple, independent health care providers submit requests for access to electronic records.
